(19) United States
(12) Patent Application Publication
(10) Pub. No.: US 2012/0023448 A1
(43) Pub. Date: Jan. 26, 2012

(54) Relational Service System and Method for Generating an Input Method

(75) Inventor: John LIN, Xizhi City (TW)

(73) Assignee: IQ Technology Inc.

(21) Appl. No.: 12/843,026

(22) Filed: Jul. 24, 2010

(51) Int. Cl. G06F 17/30; G06F 3/048

(52) U.S. Cl. 715/825; 707/722; 707/E17.047

(57) ABSTRACT

A relational service system for generating an input method is disclosed; the system uses an input unit to provide phonetic symbol and symbol input for a user, transmits an input string by the user to a temporary storing unit for display and selection, and then transmits the selected input string back to the input unit. When the input string is in the temporary storing unit, a analysis unit breaks the input string to obtain one or more words and analyzes the word to find a keyword, then a decision unit uses the keyword to search in a database to determine if there's an associated word or phrase related to the word, if so, then a prompting unit is enabled to use a relational information display unit to display related information in a tree structure, and finally a service unit uses an associated word or phrase selected by the user to initiate a remote service, such as ordering food, restaurant reservation, or booking movie tickets.

### BACKGROUND OF THE INVENTION

1. Field of the Invention

The present invention relates to a relational service system and method for generating an input method, and more particularly, to a relational service system and method for determining a keyword when a user input an input string to a mobile communication device and providing remote call service related to the specific keyword.

2. Description of the Prior Art

As mobile communication devices prevail, more people rely on the mobile communication devices to communicate or do business in daily lives. Mobile communication devices provide various functions such as voice phone, text message, multimedia message, e-mail, multimedia player, and camera; furthermore, mobile communication devices also provide networking (data, 3.5G, or Internet) functions, which have become indispensable for users.

Aiming to provide more functions to the mobile communication devices, many software or hardware vendors have proposed various kinds of input method to enable the human interfaces (key pad or touch panel) and to facilitate usability. On the other hand, some carriers or Internet service providers focus on making services more diversified and convenient to help users access the network for all kinds of service.

However, there's no way to combine a fast and convenient input method with keyword-based search functions to automatically determine if the user needs any services related to the input word/string (keyword), such as ordering food, booking movie ticket or shopping, and then to provide links for the user to select a remote service via various kinds of mobile data network.

In view of the deficiencies of the prior art techniques, after years of constant researches, the inventor has successfully proposed a relational service system for generating an input method in the present invention.

### SUMMARY OF THE INVENTION

It is an object of the present invention to provide a relational service system for generating an input method, wherein the string inputted by the user is displayed in a temporary storing unit for the user to select correct words, and the temporary storing unit breaks the string into one or more keywords to provide relational service accordingly.

It is another object of the present invention to provide a relational service system for generating an input method and a method thereof; the system uses a determined keyword to provide relational service links in a tree topology.

It is still another object of the present invention to provide a relational service system for generating an input method and a method thereof, wherein the system uses a local database to store information related to the user to provide more suitable and personal relational service links.

In order to achieve the above objects, a relational service system for generating an input method and a method thereof are disclosed; the system uses an input unit connecting with an input interface of a mobile communication device to provide phonetic symbol and symbol input for a user, transmits an input string, word, or symbol inputted by the user to a temporary storing unit for display and selection, and then transmits the selected input string, word or symbol back to the input unit. When the input string, word, or symbol is in the temporary storing unit, an analysis unit breaks the input string to obtain one or more words and analyzes the word to find a keyword, then a decision unit uses the keyword to search in a local or external database to determine if there's an associated word or phrase related to the word, if so, then a prompting unit is enabled to use a relational information display unit to display related information in a tree structure, and finally a service unit uses an associated word or phrase selected by the user to initiate a remote service, such as ordering food, restaurant reservation, or booking movie tickets.

### BRIEF DESCRIPTION OF THE DRAWINGS

FIG. 1 illustrates a structural view of a relational service system for generating an input method in the present invention;

FIG. 2 illustrates a flowchart of a relational service method for generating an input method in the present invention;

FIG. 3A to FIG. 3D illustrate a first embodiment of the relational service method for generating an input method in the present invention; and

FIG. 4A to FIG. 4E illustrate a second embodiment of the relational service method for generating an input method in the present invention.

### DETAILED DESCRIPTION OF THE PREFERRED EMBODIMENT

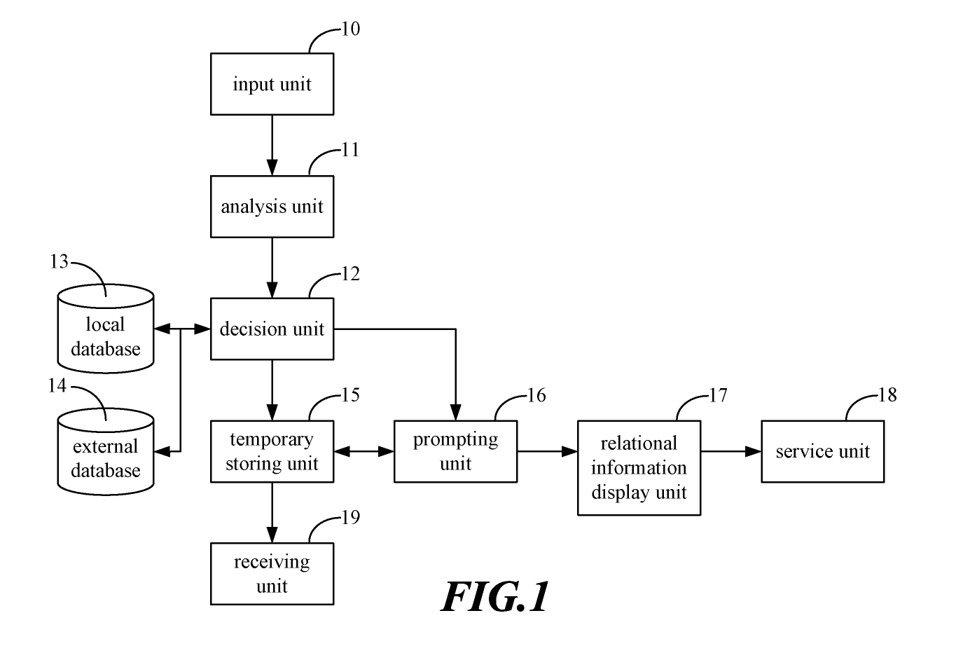

Please refer to FIG. 1 for a structural view of a relational service system for generating an input method in the present invention, wherein the system comprises:

an input unit 10 connected with an input interface of a mobile communication device for providing word and symbol input, wherein an input string, word, or symbol inputted by a user using the word or symbol input is stored in a temporary storing unit 15 for modification or selection, and the input string, word, or symbol from the input unit 10 is displayed in the temporary storing unit 15;

an analysis unit 11 for breaking the input string from the input unit 10 to obtain one or more keywords or key terms;

a decision unit 12 for determining if the keyword or key term from the analysis unit 11 is related to a existed keyword or key term in a local database 13 or external database 14;

a prompting unit 16 for highlighting a determined keyword or key term from the decision unit 12, such as underlining the word or shading the word background;

a relational information display unit 17 for displaying the determined keyword or associated information-carrying word/phrase (or item) from the prompting unit 16 in a tree structure, and initiating the related service;

a service unit 18 for providing a related service link with an external system based on the keyword or key term selected by the user on the prompting unit 16 and relational information display unit 17, wherein the service unit 18 uses a 2.5G, 3G or wireless network to link with an external ticket booking or meal ordering system;

a local database 13 integrated in the mobile communication device, wherein the local database provides keywords or key terms, and corresponding services, additionally, the local database 13 can integrate user related information, such as the residential area and age; and

an external database 14 for providing a relational service of the keyword or the key term to the mobile communication using networking connection (such as 2.5G, 3.5G or wireless network) to link with the external system.

Here, the local database 13 or the external database 14 uses a tree topology to set every keyword (or key term) as a node; each node can connect to another node corresponding to another keyword or key term in another tree structure for initiating a certain service.

The system also comprises a receiving unit 16 for receiving a selected string, word or symbol from the temporary storing unit 15 and transmitting the selected string, word or symbol to a target, wherein the target of the receiving unit is a text message, an e-mail, or other text input applications.

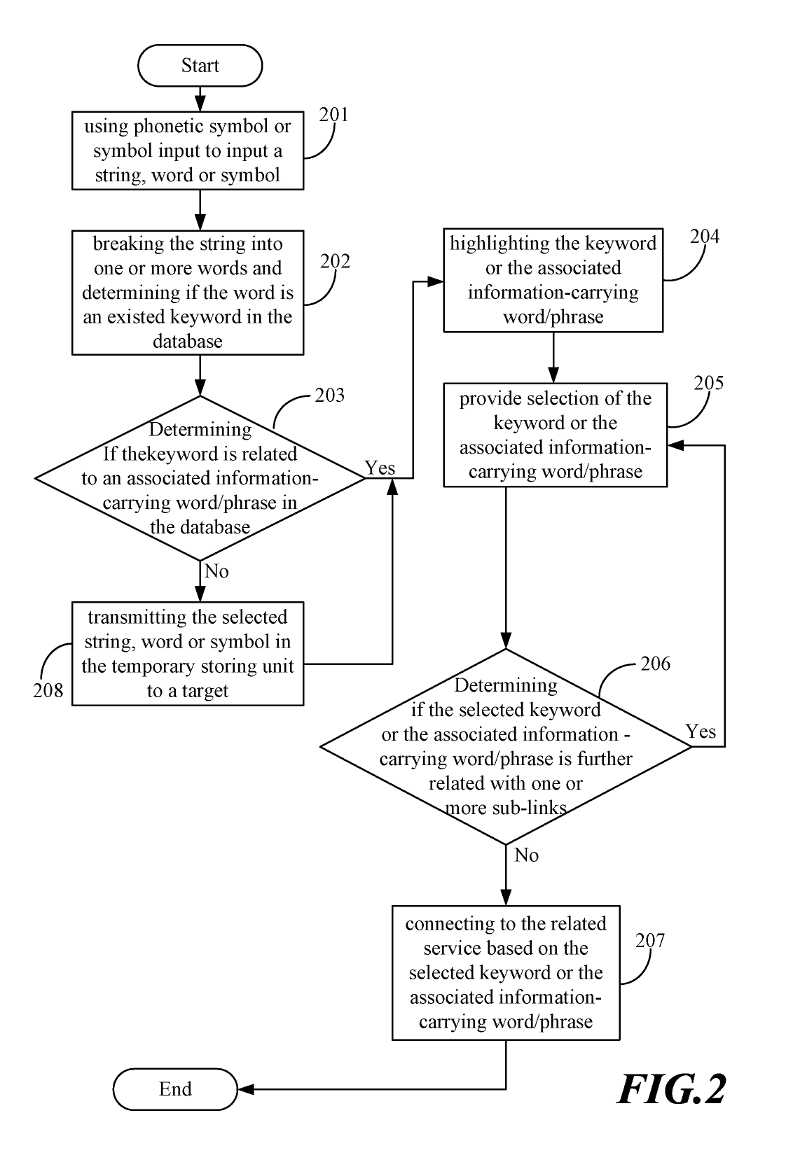

Please refer to FIG. 2 for a flowchart of a relational service method for generating an input method in the present invention; the method comprises the following steps:

Step 1: using phonetic symbol or symbol input to input a string, word or symbol and storing it in a temporary storing unit 201;

Step 2: breaking the string into one or more words and determining if the word is a existed keyword or key term in a local database or an external database 202;

wherein the local database further comprises related information of the user of the mobile communication device, such as residential area or age;

Step 3: if so, then determining if the keyword is related to a associated information-carrying word/phrase in the local database or the external database 203;

if so, then the method proceeds to step 4;

if not, then the method proceeds to step 5;

Step 4: highlighting the keyword or the associated information-carrying word/phrase 204 to provide selection of the keyword or the associated information-carrying word/phrase 205, and then determining if the selected keyword or the associated information-carrying word/phrase is further related with one or more sub-links 206, if so, then go back to process 205 to provide selection of the keyword or the associated information-carrying word/phrase related to the one or more sub-links, and finally connecting to the related service based on the selected keyword or the associated information-carrying word/phrase 207; and

Step 5: transmitting the selected string, word or symbol in the temporary storing unit to a target (the target of the receiving unit is a text message, an e-mail, or other text input applications.) and ending the process 208.

In step 3, the method uses a network service (such as 2.5G, 3.5G or wireless network) to connect with the external database so as to provide relational services corresponding to the keyword or key term.

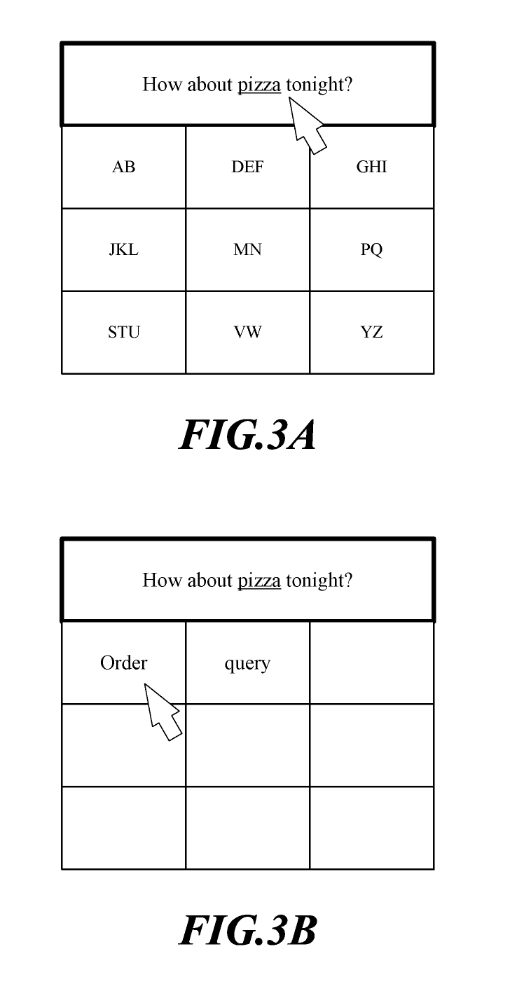

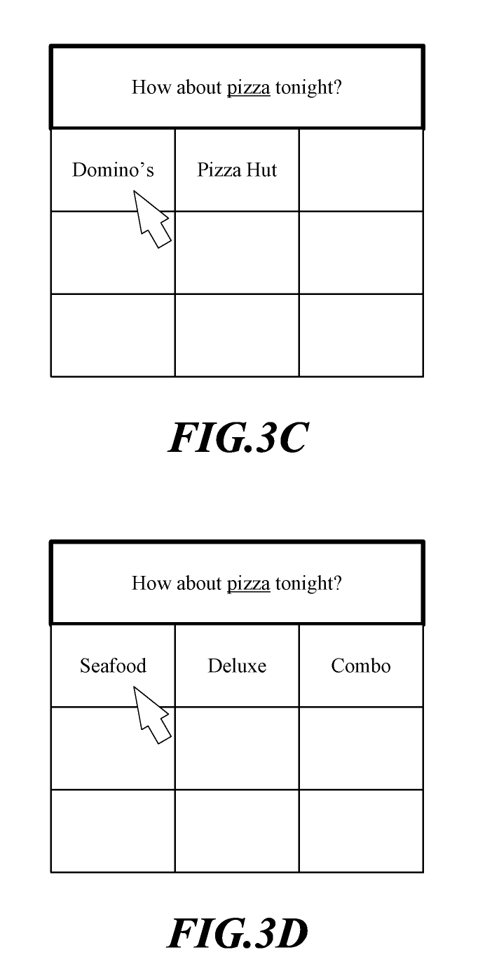

Please refer to FIG. 3A to FIG. 3D illustrate a first embodiment of the relational service method for generating an input method in the present invention, wherein the first embodiment shows an example of how to combine the input method and the meal ordering system.

When the system receives an input string and the temporary storing unit shows “How about pizza tonight?” The system breaks the string and determines “pizza” to be the keyword, which is highlighted by an underline. When the user selects “pizza”, the system will provide a menu of “order ” or “query”; if the user chooses “order”, a sub menu showing “Domino's” or “Pizza Hut” will pop out; and when the user choose “Domino's”, a sub menu showing “see food”, “delux”, or “combo” will pop out; and finally the user chooses “seafood”, the system will initiate remote service to order pizza at Domino's.

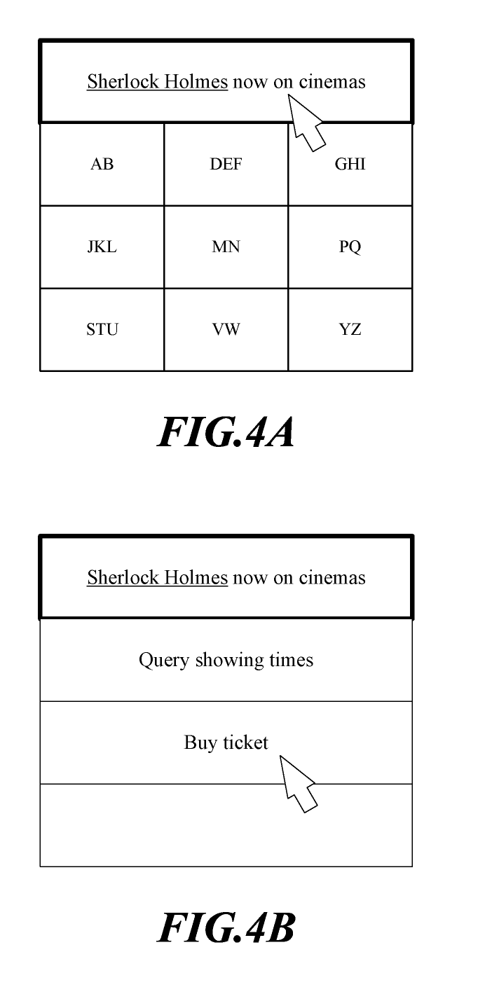

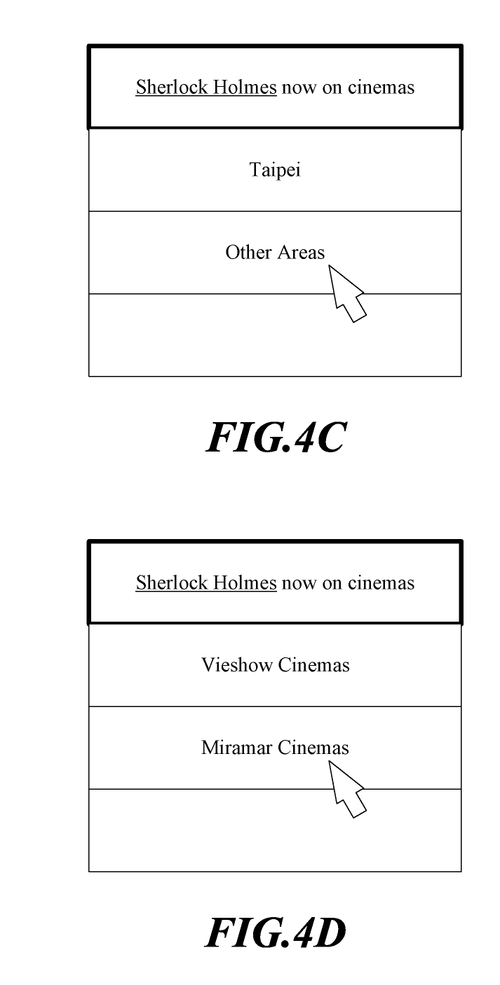

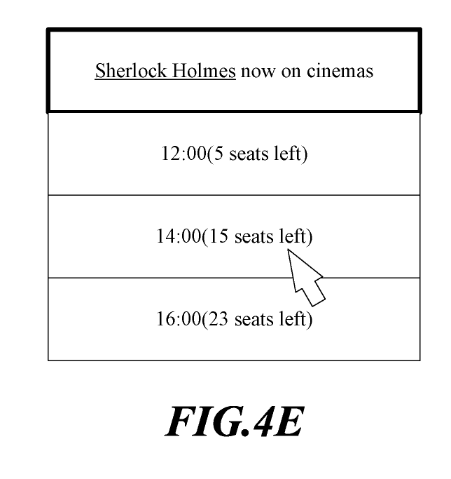

Please refer to FIG. 4A to FIG. 4E for a second embodiment of the relational service method for generating an input method in the present invention; wherein the second embodiment shows an example of how to combine the input method and the ticket booking system.

When the system receives an input string and the temporary storing unit shows “Sherlock Holmes now on cinemas” The system breaks the string and determines Sherlock Holmes” to be the keyword, which is highlighted by an underline. When the user selects “Sherlock Holmes”, the system provides sub menu showing “query showing times” or “buy ticket”; if the user chooses “buy ticket”, the system will continue to provide sub menu showing “Taipei” or “Other areas”; if the user chooses “Taipei”, then a sub menu showing “Vieshow Cinemas” or “Miramar Cinemas” will pop out; and finally the user chooses “Miramar”, the system provides a sub menu showing “12:00, 5 seats left”, “14:00, 15 seats left”, or “16:00, 23 seats left”, afterwards the system will initiate ticket booking process for the selected time.

The present invention discloses a relational service system for generating an input method and a method thereof, while compared to other prior art techniques, is advantageous in:

1. The present invention discloses a method to provide basic input function and related services according to the input string by the user; the method can provide direct link to the service without switching to other item or page to facilitate a user-oriented service.

2. The method provides a database which can integrate information specific to the user, such as the residential area, age and gender, etc., to improve the service.

3. The method uses a tree topology to set every keyword (or key term) as a node; each node can connect to another node in another tree structure for showing relational service links.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A relational service system for generating an input method comprising:
an input unit connected with an input interface of a mobile communication device for providing word and symbol input, wherein a input string, word, or symbol inputted by a user using the word or symbol input is displayed in a temporary storing unit;
an analysis unit for breaking the input string to obtain a keyword or a key term;
a decision unit for determining if the keyword or key term from the analysis unit is related to a existed keyword or key term in a local database or external database;
a prompting unit for highlighting a determined keyword or key term from the decision unit;
a relational information display unit for displaying the determined keyword or key term from the prompting unit and a relational service in a tree structure;
a service unit for providing a related service link with an external system based on the keyword or key term selected by the user using the prompting unit and relational information display unit;
a local database integrated in the mobile communication device, wherein the local database provides keywords or key terms;
an external database for providing a relational service of the keyword or the key term to the mobile communication using networking connection to link with the external database; and
a receiving unit for receiving a selected string, word or symbol from the temporary storing unit and transmitting the selected string, word or symbol to a target.

2. The relational service system for generating an input method as claimed in claim 1, wherein the temporary storing unit is provided for correction and selection of the input string.

3. The relational service system for generating an input method as claimed in claim 1, wherein the prompting unit highlights the keyword or key term by underlining the word or shading the word background.

4. The relational service system for generating an input method as claimed in claim 1, wherein the local database or the external database uses a tree structure to relate to the keyword or key term to another keyword or key term of another tree structure to provide related service connection.

5. The relational service system for generating an input method as claimed in claim 1, wherein the local database further comprises related information of the user of the mobile communication device.

6. The relational service system for generating an input method as claimed in claim 1, wherein the service unit uses a 2.5G, 3G or wireless network to link with the external database for providing a relational service.

7. The relational service system for generating an input method as claimed in claim 1, wherein the target of the receiving unit is a text message or an e-mail.

8. A relational service method for generating an input method, comprising the following steps:
step 1: using phonetic symbol or symbol input to input a string, word or symbol and storing it in a temporary storing unit;
step 2: breaking the string into one or more words and determining if the word is a keyword in a local database or an external database;
step 3: if so, then determining if the keyword is related to a associated information-carrying word/phrase in the local database or the external database;
if so, then the method proceeds to step 4;
if not, then the method proceeds to step 5;
step 4: highlighting the keyword or the associated information-carrying word/phrase to provide selection of the keyword or the associated information-carrying word/phrase, and then determining if the selected keyword or the associated information-carrying word/phrase is further related with one or more sub-links, if so, then providing selection of the keyword or the associated information-carrying word/phrase related to the one or more sub-links, and finally connecting to the related service based on the selected keyword or the associated information-carrying word/phrase; and
step 5: transmitting the selected string, word or symbol in the temporary storing unit to a target and ending the process.

9. The relational service method for generating an input method as claimed in claim 8, wherein the local database further comprises related information of the user of the mobile communication device.

10. The relational service method for generating an input method as claimed in claim 8, wherein the step 2 to step 5 use a 2.5G, 3G or wireless network to link with the external database for providing a relational service.

11. A computer readable medium for storing a program loaded by a computer to execute the method as claimed in claim 8.
